(19) United States
(12) Patent Application Publication
(10) Pub. No.: US 2025/0138879 A1
(43) Pub. Date: May 1, 2025

(54) MULTITASKING RPA OPERATION SYSTEM AND METHOD

(71) Applicant: Infofla, Inc., Seoul (KR)

(72) Inventor: In Mook Choi, Seongnam-si (KR)

(21) Appl. No.: 18/923,858

(22) Filed: Oct. 23, 2024

(30) Foreign Application Priority Data
Oct. 31, 2023 (KR) 10-2023-0148099

(51) Int. Cl. G06F 9/48

(52) U.S. Cl. CPC G06F 9/4881

(57) ABSTRACT

An apparatus for executing multitasking RPA includes a scheduler configured to receive registration of a schedule for executing RPA jobs at a predetermined time from a user, an RPA job queue configured to receive registration of RPA jobs to be performed on a user PC so that the scheduler executes a job scenario at a predetermined time, each of the RPA jobs including scripts to execute the job scenario, and an RPA agent configured to receive a signal reporting start of a job from the RPA job queue, request a job to be performed from the RPA job queue, and receive a job of a corresponding type when the requested job of the corresponding type is in the RPA job queue, wherein the RPA agent includes an RPA engine and a multitasking manager.

### RELATED APPLICATION(S)

This application claims priority to Korean Patent Application No. 10-2023-0148099, filed on Oct. 31, 2023, the entirety of which is incorporated by reference herein.

### BACKGROUND OF THE INVENTION

### Field of the Invention

The present disclosure relates to RPA (Robotic Process Automation), and more particularly to a system and method for executing RPA through multitasking.

### Description of the Related Art

RPA means that repetitive tasks are performed by software robots in place of people on computers.

As the use of RPA expands, RPA has been applied not only to automation of individual jobs but also to automation of large-scale jobs. In particular, in the case of IT service automation jobs, since specific jobs such as monitoring are repeatedly executed for a long time on hundreds to thousands of devices or services, work efficiency may greatly vary depending on the processing speed of RPA.

Existing RPA operates in a sequential execution mode where one job is completed and then the next job is executed. However, in the case of web service monitoring, after entering a search term or clicking on a menu item, RPA needs to stop and wait until a result page is displayed on a screen, and then a series of operation processes is performed to repeat entering and then waiting.

Conventional art Korean Patent Publication No. 10-2021-0064186 provides a system and method for performing an RPA workflow. An instruction is received to execute a scheduled job to perform an RPA workflow for a user associated with a user group. A robot is dispatched to a computing device to execute a job for performing an RPA workflow. A scheduler schedules when the workflow is to be executed by the robot. A scheduler 502 schedules a robot group 1 (508-A), a robot group 2 (508-B), . . . , a robot group N (508-N). In Korean Patent Publication No. 10-2021-0064186, the scheduler schedules when a workflow is to be executed by a robot, and a VDI factory initiates a robot 510-N and performs a workflow 1-1 according to a set order, and when the robot 510-N completes the workflow 1-1, the VDI factory shuts down the robot 510-N. Therefore, Korean Patent Publication No. 10-2021-0064186 discloses operation in a sequential execution mode in which one job is completed and then the next job is executed similarly to conventional RPA, and in the case of web service monitoring, after entering a search term or clicking on a menu item, RPA needs to stop and wait until a result page is displayed on a screen.

### SUMMARY OF THE INVENTION

Therefore, it is necessary to improve an operation method from a sequential execution mode to an actual multitasking mode, such as having RPA execute input of a lower priority job while waiting for processing of a higher priority job, thereby significantly improving an execution speed of the overall job.

A system for executing multitasking RPA according to an embodiment of the present disclosure for solving the above-described problem may significantly improve the execution speed of the entire job.

In accordance with an aspect of the present disclosure, the above and other objects can be accomplished by the provision of a system for executing multitasking RPA including a user PC, the system including an RPA agent, and a server including an IT operation management system, wherein the server includes a scheduler configured to receive registration of a schedule for executing RPA jobs at a predetermined time from a user, and an RPA job queue configured to receive registration of RPA jobs to be performed on a user PC so that the scheduler executes a job scenario at a predetermined time, each of the RPA jobs including scripts to execute the job scenario, the user PC includes an RPA agent to perform a job received from the server, and the RPA agent includes a web socket configured to receive a signal reporting start of an RPA job from the server, request a job to be performed from the RPA job queue of the server, and receive a job of a corresponding type when the requested job is in the RPA job queue, an RPA engine configured to perform the job of the corresponding type according to scripts for execution of tasks for each of RPA jobs in the user PC, and a multitasking manager configured to instruct the RPA engine to perform a job to be performed through multitasking by changing the corresponding job to another job when a plurality of RPA jobs is present and delay occurs in an executed RPA job.

In another embodiment of the present disclosure, the multitasking manager may determine change to another job based on one or more of whether there is code instructing change to another job at a script location included in a job to be performed, or whether a waiting period greater than or equal to a designated amount of time occurs from a target server or service performing the job during the job.

In another embodiment of the present disclosure, whether the waiting period greater than or equal to the designated amount of time occurs may be determined based on whether a certain amount of time has elapsed regardless of result confirmation after the job starts.

In accordance with another aspect of the present disclosure, there is provided an apparatus for executing multitasking RPA, the apparatus including a scheduler configured to receive registration of a schedule for executing RPA jobs at a predetermined time from a user, an RPA job queue configured to receive registration of RPA jobs to be performed on a user PC so that the scheduler executes a job scenario at a predetermined time, each of the RPA jobs including scripts to execute the job scenario, and an RPA agent configured to receive a signal reporting start of a job from the RPA job queue, request a job to be performed from the RPA job queue, and receive a job of a corresponding type when the requested job of the corresponding type is in the RPA job queue, wherein the RPA agent includes an RPA engine configured to perform the job of the corresponding type according to scripts for execution of tasks for each of RPA jobs, and a multitasking manager configured to instruct the RPA engine to perform a job to be performed through multitasking by changing to another job when a plurality of RPA jobs is present and delay occurs in an executed RPA job.

In accordance with a further aspect of the present disclosure, there is provided a method of executing multitasking RPA in a server including an IT operation management system and a user PC, the method including a step a) of registering, by the server, a schedule for executing RPA jobs at a predetermined time in a scheduler, a step b) of registering, by the server, a new job in an RPA job queue configured to receive registration of RPA jobs to be performed on a user PC so that the scheduler executes a job scenario at a predetermined time, each of the RPA jobs including scripts to execute the job scenario, a step c) of transmitting, by the scheduler, a signal reporting start of the RPA job to an RPA agent of the user PC at a predetermined time, a step d) of requesting a new job from the RPA job queue by the RPA agent of the user PC, a step e) of transmitting a new job to the RPA agent of the user PC by the RPA job queue when the new job is in the RPA job queue, a step f) of instructing, by a multitasking manager, an RPA engine configured to perform an RPA job, to perform a job to be performed through multitasking by changing to another job when the RPA agent of the user PC includes the multitasking manager configured to determine change to another job and the RPA engine configured to execute the RPA job, a plurality of RPA jobs is present, and delay occurs in an executed RPA job, and a step g) of performing a job by the RPA engine of the RPA agent instructed by the multitasking manager.

In accordance with another aspect of the present disclosure, the method may further include a step h) of collecting, by the RPA agent, a job result performed after the step g).

In accordance with another aspect of the present disclosure, the method may further include a step i) of repeating steps d) to g) until the job present in the multitasking manager is completed.

In accordance with another aspect of the present disclosure, the step of instructing the RPA engine to perform the job to be performed through multitasking may include determining change to another job based on one or more of whether there is code instructing change to another job at a script location included in a job to be performed, or whether a waiting period greater than or equal to a designated amount of time occurs from a target server or service performing the job during the job.

In accordance with another aspect of the present disclosure, whether the waiting period greater than or equal to the designated amount of time occurs may be determined based on whether a certain amount of time has elapsed without receiving result confirmation from result loading after starting a job.

In accordance with a further aspect of the present disclosure, there is provided a method of executing multitasking RPA, the method including a step a) of registering, by a user, a schedule for executing RPA jobs at a predetermined time in a scheduler, a step b) of registering a new job in an RPA job queue configured to receive registration of RPA jobs to be performed on a user PC so that the scheduler executes a job scenario at a predetermined time, each of the RPA jobs including scripts to execute the job scenario, a step c) of transmitting, by the scheduler, a signal reporting start of the RPA job to an RPA agent at a predetermined time, a step d) of requesting a new job from the RPA job queue by the RPA agent, a step e) of transmitting a new job to the RPA agent by the RPA job queue when the new job is in the RPA job queue, a step f) of instructing, by a multitasking manager, an RPA engine configured to perform an RPA job, to perform a job to be performed through multitasking by changing to another job when the RPA agent includes the multitasking manager configured to determine change to another job and the RPA engine configured to execute the RPA job, a plurality of RPA jobs is present, and delay occurs in an executed RPA job, and a step g) of performing a job by the RPA engine instructed by the multitasking manager.

In accordance with a further aspect of the present disclosure, there is provided a computer-readable recording medium storing a program to execute commands for performing the method of executing multitasking RPA using a computer.

In addition, it is possible to further provide other methods, other systems, and computer programs for executing the methods to implement the present disclosure.

Other aspects, features, and advantages other than those described above will become apparent from the following drawings, claims and detailed description of the disclosure.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is an example diagram of a sequential execution mode in which conventional RPA executes jobs;

FIG. 2 is an example diagram of RPA executing a multitasking mode according to an embodiment of the present disclosure;

FIG. 3 is an example diagram of a system for executing multitasking RPA that operates RPA in a multitasking mode and a process of executing RPA through multitasking according to an embodiment of the present disclosure;

FIG. 4 is an example flowchart of a process for preparation until execution of RPA on a server of the system for executing multitasking RPA according to an embodiment of the present disclosure;

FIG. 5 is an example flowchart of an RPA agent performing jobs through multitasking in the system for executing multitasking RPA according to an embodiment of the present disclosure; and

FIG. 6 is an example diagram of an apparatus for executing multitasking RPA according to an embodiment of the present disclosure.

### DETAILED DESCRIPTION OF THE INVENTION

Advantages and characteristics of the present disclosure, and methods of achieving the advantages and characteristics will become clear with reference to embodiments described in detail in conjunction with the accompanying drawings. However, it should be understood that the present disclosure is not limited to the embodiments presented below, may be implemented in various different forms, and includes all changes, equivalents, and substitutes included in the spirit and technical scope of the present disclosure. The embodiments presented below are provided to complete the disclosure of the present invention and to fully inform those skilled in the art of the scope of the disclosure to which the present invention pertains. In describing the present disclosure, when it is determined that a detailed description of a related known technology may obscure the gist of the present disclosure, the detailed description will be omitted.

Terms used in this application are only used to describe specific embodiments, and are not intended to limit the present disclosure. Singular expressions include plural expressions unless the context clearly dictates otherwise. In this application, terms such as “comprise” or “have” are intended to designate that there is a feature, number, step, operation, component, part, or combination thereof described in the specification, and it should be understood that the terms do not preclude the possibility of the presence or addition of one or more other features, numbers, steps, operations, components, parts, or combinations thereof. Terms such as first and second may be used to describe various components. However, components should not be limited by the terms. These terms are only used for the purpose of distinguishing one component from another.

Hereinafter, embodiments according to the present disclosure will be described in detail with reference to the accompanying drawings, and in the description with reference to the accompanying drawings, the same or corresponding components are given the same reference numerals, and redundant descriptions thereof will be omitted.

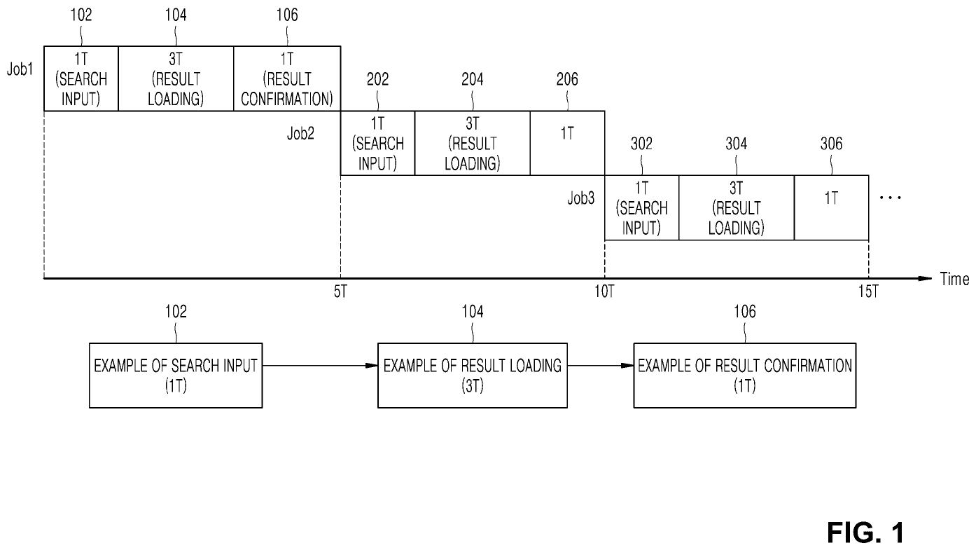

FIG. 1 is an example diagram of a sequential execution mode in which conventional RPA executes jobs.

When conventional RPA executes job 1 (Job1), it takes 1 second (1T) for search input (102), 3 seconds (3T) for result loading (104), and 1 second (1T) for result confirmation (106), taking a total of 5 seconds (5T) to complete job 1 (Job1).

Therefore, when a series of jobs (102, 104, and 106) of job 1 (Job1), a series of jobs (202, 204, and 206) of job 2 (Job2), and a series of jobs (302, 304, and 306) of job 3 (Job3) are all completed, a total of 15 seconds (15T) is required.

Existing RPA products only operate in the sequential execution mode, and thus when there are several jobs, the jobs are executed one by one in order and completed. Therefore, when checking normality of thousands of services, a long execution time and multiple RPA introduction costs are required.

In the case of web service checking, in general, a sequence of URL input, screen loading, and result screen confirmation is repeated. RPA needs to wait for a certain amount of time, mainly during a screen loading part, which leads to an increase in operating time.

In the case of IT operation management work, RPA jobs are repeatedly executed for long periods of time on thousands to tens of thousands of devices or services. In particular, in the case of web services, most of the waiting time is due to delay in loading web screens, and thus improvement of an existing RPA sequential job method is necessary.

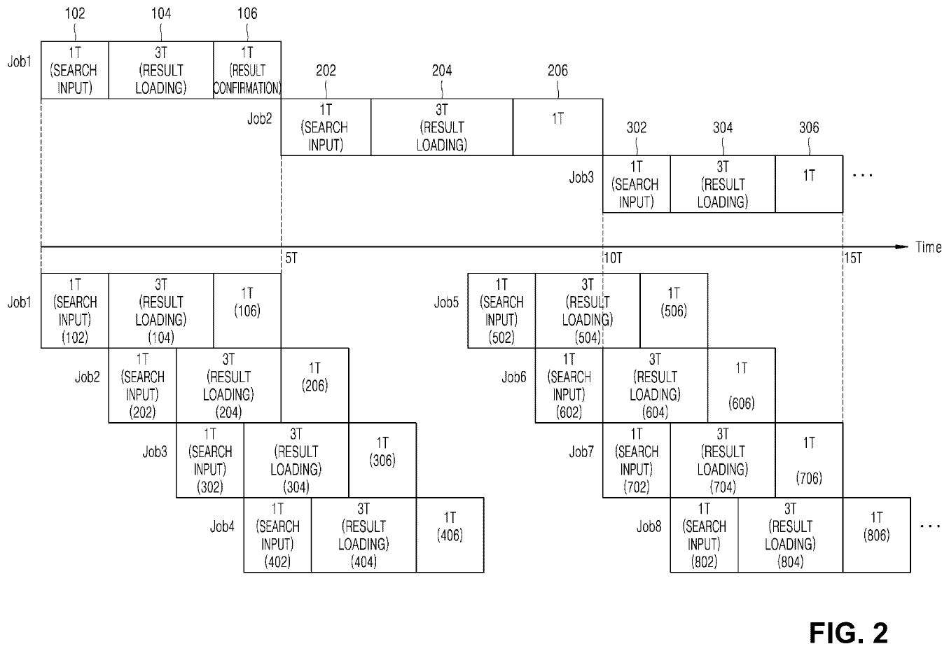

FIG. 2 is an example diagram comparing job completion times of the conventional sequential execution mode of FIG. 1 and the multitasking mode according to an embodiment of the present disclosure.

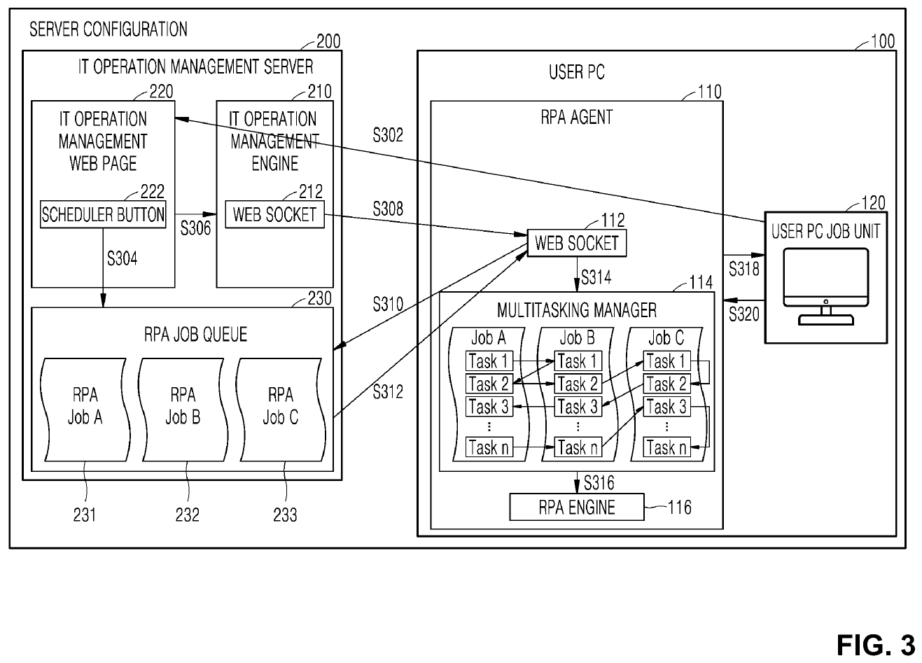

In the RPA job processing of the multitasking mode of the present disclosure (FIGS. 3 to 6), when there is a plurality of RPA jobs (Job1, Job2, Job3, Job4, Job5, Job6, Job7, and Job8) and delay occurs in executing RPA job 1 (Job1) to job 7 (Job7), the jobs (Job1 to Job8) may be processed through multitasking by changing (switching) to other jobs (Job2, Job3, and Job4).

When the jobs to be executed by RPA (Job1 to Job8) are processed by the sequential execution mode, from job 1 (Job1) to job 8 (Job8), it takes 5 seconds (5T) for search input (102), search result loading (104), and result confirmation (106) in job 1 (Job1), it takes 5 seconds (5T) for search input (202), search result loading (204), and result confirmation (206) in job 2 (Job2), it takes 5 seconds (5T) for search input (302), search result loading (304), and result confirmation (306) in job 3 (Job3), it takes 5 seconds (5T) for search input (402), search result loading (404), and result confirmation (406) in job 4 (Job4), it takes 5 seconds (5T) for search input (502), search result loading (504), and result confirmation (506) in job 5 (Job5), it takes 5 seconds (5T) for search input (602), search result loading (604), and result confirmation (606) in job 6 (Job6), it takes 5 seconds (5T) for search input (702), search result loading (704), and result confirmation (706) in job 7 (Job7), and it takes 5 seconds (5T) for search input (802), search result loading (804), and result confirmation (806) in job 8 (Job8). Therefore, it takes 40 seconds (8*5T=40T) for a total of 8 jobs to process the jobs to be executed by RPA (Job1 to Job8).

However, in the multitasking mode of the present disclosure (FIGS. 3 to 6), when delay of 1 second (1T) occurs in RPA job 1 (Job1) to job 7 (Job7) being executed, if an RPA engine is set to execute up to 4 jobs through multitasking, a multitasking operation may be configured so that switching to other jobs (Job2, Job3, and Job4) occurs while starting a job of one job (Job1), and other jobs (Job6, Job7, and Job8) are performed while starting a job of one job (Job5). In this case, a time required to process the jobs (Job1 to Job8) to be executed by RPA is 16 seconds (16T), and thus 2.5 times (40/16=2.5) a time may be save when compared to FIG. 1.

In addition, an RPA execution method according to a sequential method of FIG. 1 takes a total of 15 seconds (15T) when job 1 (Job1), job 2 (Job2), and job 3(Job3) are performed. On the other hand, according to a multitasking operation method, which is an embodiment of the present disclosure, when performing the multitasking operation method of the present disclosure (FIG. 3 to FIG. 6), up to Job7 (702, 704, and 706) is completed within 15 seconds, and thus it can be seen that more than twice as many RPA jobs may be processed during the same amount of time.

As shown in the table below, it was confirmed that, when the multitasking mode described in the present disclosure is utilized to compare an execution time of existing RPA, the RPA execution time is approximately 5 times shorter than when using the existing sequential RPA execution method.

TABLE 1

| | Required time in | Required time in |
|---|---|---|
| Target quantity and | existing RPA | developed RPA |
| work | sequential method | multitasking |
| Total of 10,000 | 50, 000 seconds | 10,004 seconds |
| service checking | (about 13.9 | (about 2.8 |
| targets | hours ) | hours ) |
| URL input 1 second, | | |
| Screen loading 3 | | |
| seconds on average, | | |
| result confirmation 1 | | |
| second | | |

This has an annual saving effect of 4,051 hours, which is equivalent to the annual work hours of two workers. In other words, it is possible to obtain an effect that the work of two people may be replaced by introducing RPA in the multitasking mode.

FIG. 3 is an example diagram of a system for executing multitasking RPA that operates RPA in the multitasking mode and a process of executing RPA through multitasking according to an embodiment of the present disclosure.

The system for executing multitasking RPA that operates RPA in the multitasking mode may include a user PC 100 and an IT operation management server 200 that includes an IT operation management system.

The user PC 100 may include a user PC job unit 120 displayed on a display and an RPA agent 110. The RPA agent 110 may include a web socket 112 that communicates with a web socket 212 of the server 200, a multitasking manager 114 that instructs the RPA engine to execute a job through multitasking by changing (switching) to another job when there is a plurality of jobs, and an RPA engine 116 that executes a job of the corresponding type according to scripts with regard to execution of tasks for each of the RPA jobs on the user PC. Throughout the present disclosure, the meaning that the multitasking manager 114 performs a job includes the meaning that the RPA engine 116 is instructed to perform the job so that the RPA engine 116 actually performs the job.

In another embodiment of the present disclosure, the multitasking manager 114 and the RPA engine 116 may be integrated into one multitasking RPA unit in hardware, or may be programmatically integrated into one multitasking RPA execution unit. When the multitasking manager 114 and the RPA engine 116 are integrated into one multitasking RPA unit in hardware or programmatically, the RPA job may be executed through multitasking in the one multitasking RPA unit. In order for the multitasking manager 114 and the RPA engine 116 to be programmatically integrated into one multitasking RPA unit, programming may be performed so that multitasking RPA is performed through division into a routine for multitask management and a routine for performing RPA tasks.

The web socket 112 of the RPA agent 110 may be responsible for communication to receive a signal reporting start of an RPA job from the server 200, transmit a signal indicating end of the RPA job, request a job of a corresponding type suitable therefor from an RPA job queue 230 of the server, and receive the job of the corresponding type when the requested job of the appropriate type is in the RPA job queue.

When there is a plurality of RPA jobs and delay occurs in an RPA job being executed, the multitasking manager 114 may instruct the RPA engine to execute jobs through multitasking by changing to another job.

In another embodiment according to the present disclosure, the multitasking manager 114 may determine to change to another job based on one or more of whether there is code (for example, <next task>) instructing change to another job at a script location included in a job to be performed, or whether a wait of a designated amount of time or more occurs from a target server or service performing the job in the middle of the job.

In another embodiment according to the present disclosure, whether a wait exceeding a designated amount of time occurs may be determined based on whether a certain amount of time (for example, 1 second, 2 seconds, 3 seconds, 4 seconds, 5 seconds, etc.) has elapsed without receiving result confirmation from result loading after starting a job. The certain amount of time may vary depending on the system working environment of the IT operation management system. For example, when hardware performance of the system is satisfactory, the certain amount of time may be set to be short, and when the job is not urgent, the certain amount of time may be set to be long. In another embodiment of the present disclosure, when result loading of the job is elongated based on user experience, the user may set a certain amount of time in the IT operation management system.

In another embodiment of the present disclosure, the multitasking manager 114 may apply a shorter time as the certain amount of time to a job whose result loading is consistently elongated (for example, ½ of the certain amount of time, such as 1 second, 2 seconds, 3 seconds, 4 seconds, 5 seconds, etc., 0.5 seconds, 1 second, 1.5 seconds, 2 seconds, 2.5 seconds). After starting a job, when the certain amount of time has passed regardless of result confirmation, change to another job is determined. After executing the other job, when monitoring consistent elongation of job result loading for the job before change to the other job, the multitasking manager 114 may apply a shorter certain amount of time to the job before change. For example, when result loading of JobB exceeds a specific time of 2 seconds, switching to other jobs may be performed. When the same job loading is in progress after returning to execution of the job of JobB, switching to other jobs may be performed more quickly by applying 1 second, which is half of the specific time of 2 seconds.

The IT operation management server 200 may include a scheduler 222 that receives a schedule from the user to execute RPA jobs at a set time, and the RPA job queue 230 that receives registration of RPA jobs to be performed on the user PC 100 so that the scheduler 222 executes a job scenario at a set time. Each RPA job may include scripts that execute the job scenario.

The IT operation management server 200 may include an IT operation management engine 210 including the web socket 212, a web page 220 including the scheduler 222 capable of registering a schedule, and the RPA job queue 230. The RPA job queue 230 may include job scenarios for RPA jobs, JobA 231, JobB 232, and JobC 233.

In an embodiment of the present disclosure, the IT operation management server 200 may be a web-based IT operation management system platform. The web-based IT operation management system platform may remotely receive schedules from users on user PCs on the web, communicate with the user PCs through the web sockets 112 and 212, and instruct the RPA agent 110 to perform RPA jobs according to jobs [JobA 231, JobB 232, and JobC 233] of the RPA job queue 230 designated by the scheduler 222.

The server may be a cloud server or a general independent server. The IT operation management server 200 may be ITOMS, which may be a server including the IT operation management system 200 of Infofla Co., Ltd.

The user PC 100 may access the server automatically or by activating the scheduler of the user, for example, when there is a plurality of jobs on the server, and register the scheduler (S302).

The scheduler 222 may select RPA having an execution function for the corresponding job among RPAs based on the schedule registered by the user and a job status of the RPA agent and register the necessary job in the RPA job queue 230 (S304).

When the schedule is registered, the scheduler 222 may notify the web socket 212 of the IT operation management server 200 of registration of the schedule (S306). According to registration of the schedule, the IT operation management server 200 may operate at a set time and execute a set scheduler function. The IT operation management server 200 may transmit a signal reporting start of the schedule through communication from the web socket 212 to the web socket 112 in the RPA agent 110 of the user PC 100 at a set time (S308).

The RPA agent 110 may request a job to be executed from the RPA job queue 230 of the IT operation management server 200 (S310).

The RPA job queue 230 may determine whether a job is present in the job queue, and request the RPA agent 110 to execute the first job JobA 231 according to the RPA jobs (JobA, JobB, and JobC) stored by the scheduler 222 when a job is present in the job queue. The RPA agent 110 may request that the RPA job queue 230 report whether there is an additional job again before completing the corresponding job (the first job JobA) (S310), and the RPA job queue 230 may notify the RPA agent 110 of additional job matters when there is an additional job (second job JobB) (S312), and the additional job may be repeated until the jobs (JobA, JobB, JobC, etc.) of the RPA job queue 230 are finished (S310 and S312).

The jobs (JobA, JobB, and JobC) may repeat the same work or perform substantially different work. In other words, based on a single job, a process from start to end of work by RPA may be regarded as one Job. For example, when JobA is a job for searching for a specific question, a series of tasks in which the question is understood and analyzed to generate an appropriate search term (Task1), a search site is accessed (Task2), the search site is searched for a result using the generated search term (Task3), the search result is displayed to the user (Task4), the result is analyzed and recommended according to a need of the user (Task5), and the analyzed result is distributed to the user (Task6) may be regarded as one job JobA. In addition, when JobB is a job for writing a daily newspaper article report, a series of tasks in which a list of latest articles is collected from each newspaper website (Task1), information such as an article title, a text, an image, or a link is extracted (Task2), classification is performed based on a subject, category, importance, etc. of the article (Task3), main content of the article is summarized (Task4), a daily newspaper article report is generated based on the classified article and summary (Task5), and the report is transmitted to a designated target (Task6) may be regarded as one job JobB.

Another job JobC may be the same job as JobA or JobB, and may be a different job. For example, JobC may be a job for regularly changing a password of the server, which is a different job from JobA or JobB. In this case, referring to the job JobC for regularly changing a password of the server, a series of tasks in which RPA first checks a current password of the server (Task1), the server is logged in using a server administrator account or an administrator account created by RPA itself and the password is checked (Task2), RPA generates a new password after checking the current password (Task3), the new password created by RPA is applied to the server (Task4), and a password change history is saved (Task5) may be regarded as one job JobC.

The web socket 112 in the RPA agent 110 of the user PC 100 may transmit jobs (JobA, JobB, JobC, etc.) received from the RPA job queue 230 to the multitasking manager 114 of the RPA agent 110 (S314).

When there is a plurality of RPA jobs and delay (for example, 1 second, 3 seconds, 5 seconds, etc.) occurs in the RPA job (JobA) being executed, the multitasking manager 114 of the RPA agent 110 may instruct the RPA engine 116 to perform a job to be executed through multitasking through change to another job (JobB) (S316). The multitasking manager 114 may be executed when it is possible to simply change to another job (JobB) or to change to a task for collecting a list of latest articles from each newspaper website (Task1) in the case where the job JobB is the first to start, or when a task for performing classification based on a subject, a category, an importance, etc. of an article (Task3) is changed from JobA to JobB if Task1 and Task2 have already been executed in JobB through multitasking.

When there are three jobs (JobA, JobB, and JobC) in the multitasking manager 114 of FIG. 3, and change to another job of the multitasking manager 114 is described using tasks of the three jobs (JobA, JobB, and JobC), the multitasking manager 114 may perform instruction to switch to Task2 of JobB when code <next task> is present in Task1 of JobA and/or there is delay a certain amount of time, switch to Task2 of JobA when code <next task> is present in Task1 of JobB and/or there is delay a certain amount of time, switch to Task2 of JobB when code <next task> is present in Task2 of JobA and/or there is delay a certain amount of time, switch to Task1 of JobC when code <next task> is present in Task2 of JobB and/or there is delay a certain amount of time, perform a job to Task2 of JobC when there is no code <next task> in Task1 of JobB and/or delay a certain amount of time, switch from Task2 of JobC to Task3 of JobC, switch from Task3 of JobC to Task3 of JobA, perform a job to Taskn of JobA when there is no code <next task> in Task3 of JobA and/or delay a certain amount of time, switch from Taskn of JobA to Taskn of JobB, switch from Taskn of JobB to Task3 of JobC, and perform a job to Taskn of JobC when there is no code <next task> in Task3 of JobC and delay a certain amount of time.

The RPA agent 110 may perform display on a user PC screen so that the user may confirm that the corresponding RPA job or an additional RPA job is being performed (S318).

In addition, the multitasking manager 114 of the RPA agent 110 may receive a report from the user PC job unit on whether execution results for tasks of the corresponding job being executed are being output (S320). When output is made, an instruction may be made so that a subsequent task of the job is executed in response to output.

When the job is not present in the job queue, a log is created in response to completion of processing of all given processes or in response to occurrence of an error, and a heterogeneous multi-RPA job is ended.

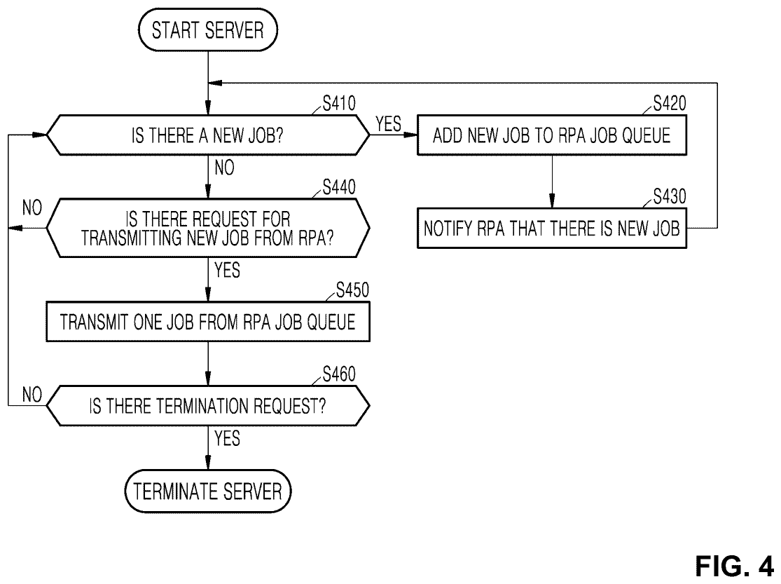

FIG. 4 is an example flowchart of a process for preparing up to execution of RPA in the IT operation management server 200 of the system for executing multitasking RPA according to an embodiment of the present disclosure.

The scheduler 222 of the IT operation management server 200 may determine whether there is a new job (for example, JobA) (S410).

When there is a new job (JobA), the new job (JobA) may be added to the RPA job queue (S420). Then, the RPA agent 110 is notified that there is the new job (JobA) (S430), and it is possible to determine again whether there is a new job (JobB) (S410). When there is a new job (JobB), the new job (JobB) may be added to the RPA job queue (S420), the RPA agent 110 is notified that there is the new job (JobB) (S430), and it is possible to determine again whether there is a new job (JobC) (S410). In this way, when there is a new job, routines of steps S410, S420, S430, and S410 may be continuously repeated, and new jobs (JobA, JobB, JobC, . . . ) may be added to the RPA job queue 230.

In step S410, when a new job (for example, JobB) is not present, it is possible to determine whether there is a request for transmitting a new job (JobA) from the RPA agent 110 (S440).

In step S440, when there is a transmission request for the new job (JoA) that has been reported to the RPA agent 110 (S430) from the RPA agent 110, one job (JobA) from the RPA job queue 230 may be transmitted to the RPA agent 110 (S450).

When there is no request for transmitting a new job (JobA) that has been previously reported from the RPA agent 110, the process returns to step S410 and it is determined whether there is a new job (for example, JobB). In step S440, when there is no request for transmitting a new job (JobA) that has been previously reported from the RPA agent 110, the process returns to step S410 to run a routine of continuously searching for a new job by continuously determining whether there is a new job.

After transmitting one job (JobA) from the RPA job queue to the RPA agent 110 (S450), it is possible to determine whether there is a termination request from user input (S460). In step S460, when there is no termination request, the process may return to step S410 to determine whether there is a new job (for example, JobB), continuously search for a new job by continuously determining whether there is a new job, and transmit jobs one by one to the RPA agent 110 from the RPA job queue 230 while repeating routines of steps S410, S440, S450, and S460.

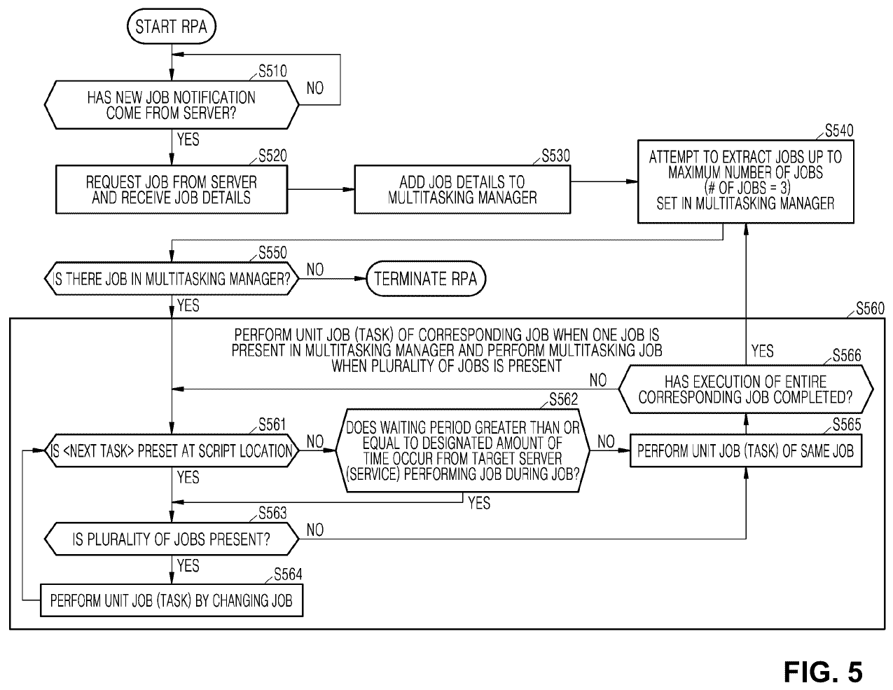

FIG. 5 is a flowchart of the RPA agent performing jobs through multitasking in the system for executing multitasking RPA according to an embodiment of the present disclosure.

When the RPA agent 110 starts RPA, it is possible to determine whether a new job notification has come from the IT operation management server 200 (S510). When a new job notification (see S430 of FIG. 4) has come from the IT operation management server 200, the RPA agent 110 may request a new job from the IT operation management server 200 and receive job details from the job queue 230 of the IT operation management server 200 (S520) (see S440 and S450 of FIG. 4).

When the job details are received from the job queue 230 of the IT operation management server 200, the job details may be added to the multitasking manager 114 (S530).

The multitasking manager 114 may attempt to extract jobs up to the maximum number of jobs set (S540). In another embodiment of the present disclosure, when the maximum number of jobs is 3 (for example, # of Jobs=3), routines of steps S510, S520, S530, and S540 may be repeated until the maximum number of jobs in the multitasking manager 114 becomes 3.

After attempting to extract jobs up to the maximum number of jobs set in the multitasking manager 114 (S540), it is determined whether there is a job in the multitasking manager 114 (S550). When there is no job in the multitasking manager 114, RPA is terminated.

When there is a job received from the job queue 230 in the multitasking manager 114 in step S550, if one job is present in the multitasking manager 114, the RPA engine 116 may be instructed to perform a unit job (task) of the corresponding job, and if a plurality of jobs in present, the RPA engine 116 may be instructed to perform a multitasking job (S560).

Step S560 of giving an instruction to perform a multitasking job may include determining whether there is a plurality of jobs (S563), giving an instruction to perform a unit job (task) of the corresponding job when one job is present in the multitasking manager 114, and giving an instruction to perform a unit job (task) by changing to another job (for example, changing from JobA to JobB or JobC) when there is a plurality of jobs (S564). In addition, step S560 of giving an instruction to perform a multitasking job may further include determining whether there is code (for example, <next task>) instructing change to another job at a script location for tasks included in a job to be performed (S561), and determining whether a waiting period greater than or equal to a designated amount of time occurs from a target server (service) during the job (S562). In addition, step S560 of giving an instruction to perform a multitasking job may further include giving an instruction to perform a unit job (task) (S564), giving an instruction to perform a unit job (task) of the same job (JobA) (S565), and determining whether the entire job (JobA) has been completed (S566).

Specifically, in step S550, when there is a job received from the job queue (230) in the multitasking manager 114, it is possible to determine whether there is code (for example, <next task>) instructing change to another job at a script location for tasks included in a job to be performed (S561). RPA jobs (JobA, JobB, and JobC) include scripts for tasks that execute job scenarios. The user may use presence or absence of code (for example, <next task>) instructing change to another job at a script location for tasks included in a job to be performed as a criterion for multitasking. In this way, before physical delay occurs until the target server or target service executing the RPA task outputs a result, the user may predict that there will be a waiting time until a result is output when a specific job is performed while writing an RPA script, and insert code instructing change to another job at a script location to induce change to another job after the job that will cause the time delay.

When code (for example, <next task>) instructing change to another job is not present at the script location (No in step S561), it is possible to determine whether a waiting period greater than or equal to a designated amount of time occurs from the target server (service) during the job as a second multitasking condition (S562). When a certain period of time delay occurs in the result output of the target server or target service where the task of the job is executed, such a condition for determining change to another job may shorten a job time by changing to another job.

When a waiting period greater than or equal to the designated amount of time occurs from the target server (service) during a job, it is possible to determine whether a plurality of job is present (S563).

In another embodiment of the present disclosure, in step S550, when there is a job received from the job queue 230 in the multitasking manager 114, it is determined whether a waiting period greater than or equal to the designated amount of time occurs from the target server (service) during the job (S562), and when a waiting period greater than or equal to the designated amount of time does not occur, it is possible to determine whether there is code (for example, <next task>) instructing change to another job at the script location for tasks included in the job to be performed (S561).

In another embodiment of the present disclosure, in response to occurrence of one or more of the case where there is code (for example, <next task>) instructing change to another job at the script location for tasks included in the job to be performed in step S561, or the case where a waiting period greater than or equal to the designated amount of time occurs from the target server or service performing the job during the job, it is possible to determine whether there is a plurality of jobs (S563).

Upon determining that there is a plurality of jobs (Yes in S563), the job may be changed (for example, change from JobA to JobB or JobC) to perform a unit job (task) (S564). In another embodiment of the present disclosure, in response to satisfying one or more of a condition that there is code (for example, <next task>) instructing change to another job at the script location for tasks included in the job to be performed in step S561, or a condition that a waiting period greater than or equal to the designated amount of time occurs from the target server or service performing the job during the job in step S562, and when there is a plurality of jobs, the multitasking manager 114 may perform a unit job (task) by changing to another job (S565). When changing to another job to perform a unit job, the multitasking manager 114 may basically change (switch) jobs to other jobs in order of starting a multitasking job (for example: JobA->JobB->JobC). However, in another embodiment of the present disclosure, a job (for example: JobC) to which a priority is assigned by the user may be allowed to switch to the corresponding job (change to another job) more frequently (for example: JobA->JobC->JobB->JobC->JobA->JobC->JobB).

After performing a unit job (task) by changing to another job (S565), routines of steps S561, S562, S563, and S564 may be repeated. Accordingly, in response to satisfying one or more of a condition that there is code (for example, <next task>) instructing change to another job at the script location for tasks included in the job to be performed in step S561, or a condition that a waiting period greater than or equal to the designated amount of time occurs from the target server or service performing the job during the job in step S562, and when there is a plurality of jobs, the multitasking manager 114 may continuously change to another job to perform the unit job (task) until a plurality of jobs is not present (S565).

When there is no code (for example, <next task>) instructing change to another job at the script location for tasks included in the job to be performed in step S561, and a waiting period greater than or equal to the designated amount of time does not occur from the target server or service performing the job during the job in step S562, the multitasking manager 114 may perform a unit job (task) of the same job (S565). Alternatively, when a plurality of jobs is not present, the multitasking manager 114 may perform a unit job (task) of the same job (S565). For example, while Task1 of the same job JobA is executed, when there is no code (for example, <next task>) instructing change to another job at the script location for tasks included in the job (JobA) to be performed in step S561, and a waiting period greater than or equal to the designated amount of time does not occur from the target server or service performing the job (JobA) during the job in step S562, or a plurality of jobs is not present and only JobA is present in the multitasking manager 114, Task2 of JobA may be executed.

A unit job (Task) of the same job may be performed (S565), and it is possible to determine whether execution of the entire job has been completed (S566). In step S566, when execution of the entire job has been completed, the process returns to attempt to extract jobs up to the maximum number of jobs set in the multitasking manager 114 (S540), and the routine after step S540 may be performed, and when there is no job in the multitasking manager 114, RPA is terminated.

When execution of the entire job is completed in step S564, step S565, or step S566, the RPA agent may be allowed to collect a result of the executed job.

When the job is terminated in step S566 and the number of jobs becomes less than the maximum, a new job request is repeated starting from step S510.

In another embodiment of the present disclosure, a method of executing multitasking RPA in a server including an IT operation management system and a user PC includes may include a step a) of registering, by the server, a schedule for executing RPA jobs at a predetermined time in a scheduler, a step b) of registering, by the server, a new job in an RPA job queue configured to receive registration of RPA jobs to be performed on a user PC so that the scheduler executes a job scenario at a predetermined time, each of the RPA jobs including scripts to execute the job scenario, a step c) of transmitting, by the scheduler, a signal reporting start of the RPA job to an RPA agent of the user PC at a predetermined time, a step d) of requesting a new job from the RPA job queue by the RPA agent of the user PC, a step e) of transmitting a new job to the RPA agent of the user PC by the RPA job queue when the new job is in the RPA job queue, a step f) of instructing, by a multitasking manager, an RPA engine configured to perform an RPA job, to perform a job to be performed through multitasking by changing to another job when the RPA agent of the user PC includes the multitasking manager configured to determine change to another job and the RPA engine configured to execute the RPA job, a plurality of RPA jobs is present, and delay occurs in an executed RPA job, and a step g) of performing a job by the RPA engine of the RPA agent instructed by the multitasking manager.

In another embodiment of the present disclosure, the method may further include a step h) of collecting, by the RPA agent, a job result performed after the step g).

In another embodiment of the present disclosure, the method may further include a step i) of repeating steps d) to g) until the job present in the multitasking manager is completed.

In another embodiment of the present disclosure, the step f) may include determining change to another job based on one or more of whether there is code instructing change to another job at a script location included in a job to be performed, or whether a waiting period greater than or equal to a designated amount of time occurs from a target server or service performing the job during the job. In another embodiment of the present disclosure, whether the waiting period greater than or equal to the designated amount of time occurs may be determined based on whether a certain amount of time has elapsed regardless of result confirmation after the job starts.

In another embodiment of the present disclosure, the step of instructing the RPA engine to perform the job to be performed through multitasking may include determining change to another job and performing the other job when the certain amount of time has elapsed regardless of result confirmation after the job starts, and then applying a shorter amount of time as the certain amount of time to a job before change by the multitasking manager 114 when monitoring that result loading of the job is consistently elongated for the job before change to another job.

When the job is not present in the job queue, a log is created in response to completion of processing of all given processes or in response to occurrence of an error, and an RPA job may be ended.

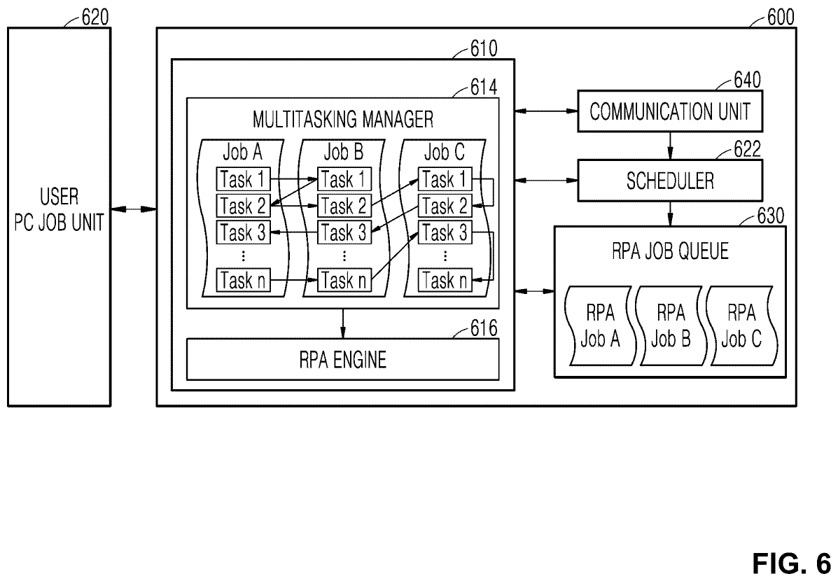

FIG. 6 is an example diagram of an apparatus for executing multitasking RPA 600 according to an embodiment of the present disclosure.

In an embodiment of the present disclosure, the apparatus for executing multitasking RPA 600 may be integrated into the user PC 100 as a system for executing multitasking RPA without the server 200 including the IT operation management system.

The user PC 100 may include a user PC job unit 620 displayed on a display and the apparatus for executing multitasking RPA 600. The apparatus for executing multitasking RPA 600 may include a scheduler 622 configured to receive registration of a schedule for executing RPA jobs at a predetermined time from the user, an RPA job queue 630 configured to receive registration of RPA jobs to be performed on a user PC so that the scheduler 622 executes a job scenario at a predetermined time, and an RPA agent 610 configured to receive a signal reporting start of a job from the RPA job queue 630, transmit a signal reporting end of the RPA job, request a job of a corresponding type suitable therefor from the RPA job queue 630, and receive a job of the corresponding type when the requested job of the corresponding type is in the RPA job queue 630. The RPA job queue 630 may include a job scenario for JobA, JobB, and JobC, which are RPA jobs. In user PCs, the scheduler 622 of the apparatus for executing multitasking RPA 600 may receive registration of schedules from users, and instruct the RPA agent 110 to perform an RPA job according to the jobs (JobA, JobB, and JobC) of the RPA job queue 630 designated by the scheduler 622. Each of the RPA jobs includes scripts for tasks executing the job scenario. For example, the apparatus for executing multitasking RPA 600 may include a communication unit 640 configured to communicate with an external device such as a web socket.

The RPA agent 110 may include an RPA engine 616 configured to perform the job of the corresponding type according to scripts for execution of tasks for each of RPA jobs, and a multitasking manager 614 configured to instruct the RPA engine 616 to perform a job to be performed through multitasking by changing to another job when a plurality of RPA jobs is present and delay occurs in an executed RPA job.

In an embodiment of the present disclosure, the multitasking manager 614 may determine change to another job based on one or more of whether there is code (for example, <next task>) instructing change to another job at a script location included in a job to be performed, or whether a waiting period greater than or equal to a designated amount of time occurs from a target server or service performing the job during the job.

In an embodiment of the present disclosure, whether the waiting period greater than or equal to the designated amount of time occurs may be determined based on whether a certain amount of time (for example, 1 second, 2 seconds, 3 seconds, 4 seconds, and 5 seconds, etc.) has elapsed without receiving result confirmation from result loading after the job starts.

To solve a problem of an existing RPA sequential job method, the present disclosure may display code (for example, Next Task), etc. instructing change to another job in an RPA script for a part in which RPA needs to wait due to reasons such as screen loading, search result display, etc. when RPA performs one automated work process, and allow a multitasking manager of RPA to perform another automated work process when encountering code (Next Task, etc.) instructing change to another job while RPA operates.

In addition, even when RPA does not encounter code instructing change to another job in a script while performing work, if response to the work, such as screen loading, search result display, etc., does not occur within a specified time (for example, 3 seconds), the multitasking manager may perform another automated work process.

The multitasking manager manages automated work processes that are or may be simultaneously performed to switches between automated work processes being performed, and enables several jobs to be performed simultaneously and efficiently.

An embodiment according to the present disclosure described above may be implemented in the form of a computer program that may be executed on a computer through various components, and such a computer program may be recorded on a computer-readable medium. At this time, the medium may include a magnetic medium such as a hard disk, a floppy disk or a magnetic tape, an optical recording medium such as a CD-ROM or a DVD, a magneto-optical medium such as a floptical disk, and a hardware device specially configured to store and execute a program instruction, such as a ROM, a RAM, and a flash memory.

Meanwhile, the computer program may be specially designed and configured for the present disclosure, or may be available by being known to those skilled in the art of computer software. Examples of the computer program may include not only machine language code generated by a compiler but also high-level language code executable by a computer using an interpreter, etc.

In the specification of the present disclosure (especially in the claims), the use of the term “the” and similar indicating terms may correspond to both singular and plural. In addition, when a range is described in the present disclosure, the invention, to which each individual value within the range is applied, is included (unless there is a statement to the contrary), which is the same as describing each individual value included in the range in the detailed description of the disclosure.

When there is no explicit order or description to the contrary for steps included in a method according to the present disclosure, the steps may be performed in an appropriate order. The present disclosure is not necessarily limited according to the described order of the steps. In the present disclosure, the use of any examples or exemplary terms (for example, etc.) is merely intended to describe the present disclosure in detail, and the scope of the present disclosure is not limited by the above examples or exemplary terms unless limited by the claims. In addition, those skilled in the art may appreciate that various modifications, combinations and changes may be made according to design conditions and factors within the scope of the appended claims or equivalents thereto.

Therefore, the spirit of the present disclosure should not be determined by being limited to the above-described embodiments, and not only the claims to be described later, but also all scopes equivalent to or equivalently changed from the scope of the claims fall within the scope of the spirit of the present disclosure.

1. A system for executing multitasking robotic process automation (RPA), the system comprising:
a user PC comprising an RPA agent; and
a server comprising an IT operation management system, wherein:
the server comprises:
a scheduler configured to receive registration of a schedule for executing RPA jobs at a predetermined time from a user; and
an RPA job queue configured to receive registration of RPA jobs to be performed on a user PC so that the scheduler executes a job scenario at a predetermined time, each of the RPA jobs comprising scripts to execute the job scenario,
the user PC comprises an RPA agent to perform a job received from the server, and
the RPA agent comprises:
a web socket configured to receive a signal reporting start of an RPA job from the server, request a job to be performed from the RPA job queue of the server, and receive a job of a corresponding type when the requested job is in the RPA job queue;
an RPA engine configured to perform the job of the corresponding type according to scripts for execution of tasks for each of RPA jobs in the user PC; and
a multitasking manager configured to instruct the RPA engine to perform a job to be performed through multitasking by changing the corresponding job to another job when a plurality of RPA jobs is present and delay occurs in an executed RPA job.

2. The system according to claim 1, wherein the multitasking manager determines change to another job based on one or more of:
whether there is code instructing change to another job at a script location included in a job to be performed; or
whether a waiting period greater than or equal to a designated amount of time occurs from a target server or service performing the job during the job.

3. The system according to claim 2, wherein whether the waiting period greater than or equal to the designated amount of time occurs is determined based on whether a certain amount of time has elapsed regardless of result confirmation after the job starts.

4. The system according to claim 3, wherein the multitasking manager monitors result loading of the corresponding job, and applies a shorter amount of time as the certain amount of time to the job whose result loading of the corresponding job is consistently elongated.

5. The system according to claim 1, wherein, when a unit job is performed by changing to another job, the multitasking manager changes the corresponding job to another job in order of starting a multitasking job.

6. The system according to claim 1, wherein, when a unit job is performed by changing to another job, the multitasking manager changes the corresponding job to another job according to a job change order to which priority is assigned by the user.

7. An apparatus for executing multitasking RPA, the apparatus comprising:
a scheduler configured to receive registration of a schedule for executing RPA jobs at a predetermined time from a user;
an RPA job queue configured to receive registration of RPA jobs to be performed on a user PC so that the scheduler executes a job scenario at a predetermined time, each of the RPA jobs comprising scripts to execute the job scenario; and
an RPA agent configured to receive a signal reporting start of a job from the RPA job queue, request a job to be performed from the RPA job queue, and receive a job of a corresponding type when the requested job of the corresponding type is in the RPA job queue,
wherein the RPA agent comprises:
an RPA engine configured to perform the job of the corresponding type according to scripts for execution of tasks for each of RPA jobs; and
a multitasking manager configured to instruct the RPA engine to perform a job to be performed through multitasking by changing to another job when a plurality of RPA jobs is present and delay occurs in an executed RPA job.

8. The apparatus according to claim 7, wherein the multitasking manager determines change to another job based on one or more of:
whether there is code instructing change to another job at a script location included in a job to be performed; or
whether a waiting period greater than or equal to a designated amount of time occurs from a target server or service performing the job during the job.

9. The apparatus according to claim 8, wherein whether the waiting period greater than or equal to the designated amount of time occurs is determined based on whether a certain amount of time has elapsed regardless of result confirmation after the job starts.

10. A method of executing multitasking RPA in a server comprising an IT operation management system and a user PC, the method comprising:
a step a) of registering, by the server, a schedule for executing RPA jobs at a predetermined time in a scheduler;
a step b) of registering, by the server, a new job in an RPA job queue configured to receive registration of RPA jobs to be performed on a user PC so that the scheduler executes a job scenario at a predetermined time, each of the RPA jobs comprising scripts to execute the job scenario;
a step c) of transmitting, by the scheduler, a signal reporting start of the RPA job to an RPA agent of the user PC at a predetermined time;
a step d) of requesting a new job from the RPA job queue by the RPA agent of the user PC;
a step e) of transmitting a new job to the RPA agent of the user PC by the RPA job queue when the new job is in the RPA job queue;
a step f) of instructing, by a multitasking manager, an RPA engine configured to perform an RPA job, to perform a job to be performed through multitasking by changing to another job when the RPA agent of the user PC comprises the multitasking manager configured to determine change to another job and the RPA engine configured to execute the RPA job, a plurality of RPA jobs is present, and delay occurs in an executed RPA job; and
a step g) of performing a job by the RPA engine of the RPA agent instructed by the multitasking manager.

11. The method according to claim 10, further comprising a step h) of collecting, by the RPA agent, a job result performed after the step g).

12. The method according to claim 10, further comprising a step i) of repeating steps d) to g) until the job present in the multitasking manager is completed.

13. The method according to claim 10, wherein the step f) comprises determining change to another job based on one or more of:
whether there is code instructing change to another job at a script location included in a job to be performed; or
whether a waiting period greater than or equal to a designated amount of time occurs from a target server or service performing the job during the job.

14. The method according to claim 13, wherein whether the waiting period greater than or equal to the designated amount of time occurs is determined based on whether a certain amount of time has elapsed regardless of result confirmation after the job starts.

15. The method according to claim 14, wherein the step f) comprises monitoring, by the multitasking manager, result loading of the corresponding job, and applying a shorter amount of time as the certain amount of time to the job whose result loading of the corresponding job is consistently elongated.

16. The method according to claim 10, wherein, when a unit job is performed by changing to another job, the multitasking manager changes the corresponding job to another job in order of starting a multitasking job.

17. The method according to claim 10, wherein, when a unit job is performed by changing to another job, the multitasking manager changes the corresponding job to another job according to a job change order to which priority is assigned by a user.

18. A method of executing multitasking RPA, the method comprising:
a step a) of registering, by a user, a schedule for executing RPA jobs at a predetermined time in a scheduler;
a step b) of registering a new job in an RPA job queue configured to receive registration of RPA jobs to be performed on a user PC so that the scheduler executes a job scenario at a predetermined time, each of the RPA jobs comprising scripts to execute the job scenario;
a step c) of transmitting, by the scheduler, a signal reporting start of the RPA job to an RPA agent at a predetermined time;
a step d) of requesting a new job from the RPA job queue by the RPA agent;
a step e) of transmitting a new job to the RPA agent by the RPA job queue when the new job is in the RPA job queue;
a step f) of instructing, by a multitasking manager, an RPA engine configured to perform an RPA job, to perform a job to be performed through multitasking by changing to another job when the RPA agent comprises the multitasking manager configured to determine change to another job and the RPA engine configured to execute the RPA job, a plurality of RPA jobs is present, and delay occurs in an executed RPA job; and
a step g) of performing a job by the RPA engine instructed by the multitasking manager.

19. The method according to claim 18, wherein the step f) comprises determining change to another job based on one or more of:
whether there is code instructing change to another job at a script location included in a job to be performed; or
whether a waiting period greater than or equal to a designated amount of time occurs from a target server or service performing the job during the job.

20. The method according to claim 19, wherein whether the waiting period greater than or equal to the designated amount of time occurs is determined based on whether a certain amount of time has elapsed regardless of result confirmation after the job starts.

21. A computer-readable recording medium storing a program to execute commands for performing the method of executing multitasking RPA according claim 10 using a computer.
